(19) United States
(12) Patent Application Publication
(10) Pub. No.: US 2001/0044803 A1
(43) Pub. Date: Nov. 22, 2001

(54) One step map retrieval by inputting a unique number

(76) Inventor: Kehyeh Szutu, Palo Alto, CA (US)

Correspondence Address: Bo-In Lin, 13442 Mandoli Drive, Los Altos Hills, CA, 94022, US

(21) Appl. No.: 09/862,845

(22) Filed: May 21, 2001

Related U.S. Application Data
(60) Provisional application No. 60/206,202, filed on May 22, 2000.

(51) Int. Cl. G06F 17/30; G01C 21/32

(52) U.S. Cl. 707/104.1; 707/10; 701/208

(57) ABSTRACT

The present invention discloses a network system. The network system includes a map server for receiving a numeric data input. The map server further includes a first database-search enabling means for enabling a first database search for determining a geographic location associated with the numeric data input. The map server further includes a second database-search enabling means for enabling a second database search for retrieving a map associated with the geographic location determined by the first database search. In a preferred embodiment, the map server further includes a first database containing data for relating the numeric data input to the geographic location. In another preferred embodiment, the map server further includes a second database containing data for relating the geographic location to the map.

This Application claims a Priority Date of May 22, 2000, benefited from a previously filed Provisional Application 60/206,202 filed on May 22, 2000 by the same Applicant of this Patent Application.

### BACKGROUND OF THE INVENTION

1. Field of the Invention

This invention relates generally to network systems for carrying out various kinds of geocentric operations over communication network s. More particularly, this invention relates to an improved system configuration and method for interactively linking a preexisting unique externally administered identifier such as a telephone number or a partial phone number, to a map showing the location for the address listed for that unique identifier, e.g., the telephone number. This invention also relates to an improved system configuration and method for organizing and accessing geocentric information.

2. Description of the Prior Art

Even though a map can be readily obtained on a web page through entering an address to an Internet web site such as www.Yahoo.com, however, it is still very inconvenient to obtain a map for the location listed for a telephone number. A person has to first carry out a search process to find out the address listed under a telephone number through a “reverse directory” and then entering the address to a map-searching web site to retrieve the map for the location listed for that telephone number. This two-steps process often become a significant limitation to certain mobile telephone users, even the users have access to the Internet through the mobile phone. The limitations may be imposed by the requirement that the mobile phone user has to key in long list of web-page universal resource locator (URL) to reach the web sites of the reverse directory to first find out the address. Then the mobile phone user has to key in the URL for the map searching web site and the address into the map searching web site to retrieve the map. Data entry with telephone keypads for URL names and address can be very time consuming and frustrating experiences, particularly when the mobile phone user is traveling at a high speed under the time constraint to reach a destination to according to a scheduled appointment.

Even though geocentric information, e.g. all shops within 5 miles of a specific location, can be retrieved over communication network, it still takes several steps to do so. A person has to first go to a portal, e.g. www.msn.com and then select Yellow-Pages and then select “Location close to” and then enter the ZIP code. This process is further inconvenienced by the fact that ZIP code might not be readily recalled for a place that one does not visit often, e.g. a friend's house.

Therefore, a need still exists in the art of network for providing a new and improved configuration and method to overcome these limitations. The improved configuration and method must provide simplified and practical network access to retrieve a map or other geocentric information without requiring multiple steps of data entry processes. A simple operation of inputting phone numbers would be sufficient to receive a map or other geocentric information for an address or for an adjacent region listed for a particular telephone number.

### SUMMARY OF THE PRESENT INVENTION

It is therefore an object of the present invention to provide a system configuration and method to simplify the map or geocentric information request and retrieval processes without requiring entering a destination address or zip code such that the aforementioned difficulties and limitations encountered in the prior art can be resolved.

Specifically, it is an object of the present invention to provide a new method and system configuration with a geocentric information server capable of either searching or linking two databases to first determine a location or an address associated with a telephone number or partial telephone number. Then, the geocentric information server either searches or enables a link to a map or geocentric information database by entering a retrieval instruction with the address or location determined from the search of the first database. The descriptions of employing two databases and two searching steps are for illustration purpose. There are many ways to implement this procedure and other possible implementations including all data are stored in one database or the databases are located on different servers over the network. The processes of retrieving a map or other geocentric information for a region or an address associated with a telephone number or a partial telephone is greatly simplified. A network or telephone user, particularly such user carrying out a map retrieval operation with a mobile phone is greatly benefited from this more convenient method of map retrieval.

Another object of the present invention is to provide a new method and system configuration by providing a map server for retrieving map associated with a user input of an unique externally administered number. User's input may be a telephone number, partial telephone number, zip code, social security, or other kinds of unique externally administered number. The system configuration and method of this invention is to perform a first database search for determining an address or location associated with the unique number entered by a network or telephone user. Then a second database search is performed to retrieve the map for the address or the location determined by the search carried out in the first database. The purpose is to simplify the map retrieval processes, particularly for a map requester not knowing the address or cannot conveniently access to a keyboard or a voice input device to enter the address identified by a list of alphanumeric characters.

Briefly, in a preferred embodiment, the present invention discloses network system. The network system includes a geocentric information server for receiving a numeric data input. The geocentric information server further includes a first database-search enabling means for enabling a first database search for determining a geographic location associated with the numeric data input. The map server further includes a second database-search enabling means for enabling a second database search for retrieving a map or other geocentric information associated with the geographic location determined by the first database search. In a preferred embodiment, the geocentric information server further includes a first database containing data for relating the numeric data input to the geographic location. In another preferred embodiment, the geocentric information server further includes a second database containing data for relating the geographic location to the map.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 is a functional block diagram showing a system configuration for an Internet map server of the present invention.

FIG. 2 is a functional block diagram showing an alternate system configuration for an Internet map server of the present invention;

FIG. 3 is a functional block diagram showing a system configuration for an Internet Directory server of the present invention.

FIG. 4 is a functional block diagram showing an alternate system configuration for an Internet directory server of the present invention.

### DETAILED DESCRIPTION OF THE PREFERRED EMBODIMENT

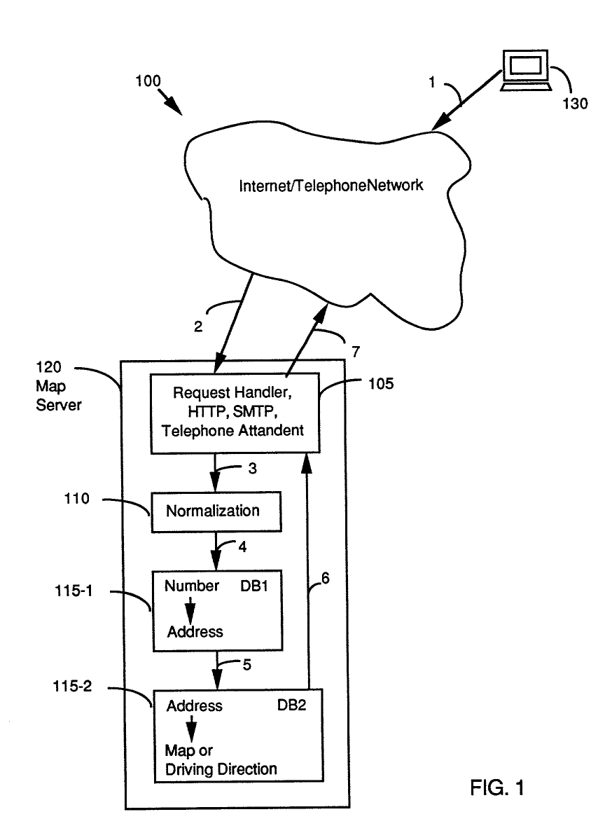

Referring to FIG. 1 for a functional block diagram showing an architecture overview of a system configuration for the present invention. The network communication system, e.g., an Internet or phone system 100, includes a map server 120. In a preferred embodiment, this map server 120 is implemented as an Internet control Web site. The map server 120 is connected to and in communication with an t user 130 requesting a map by sending a telephone number. The map server 120 includes a request handler 105 that can be implemented as a hypertext transfer protocol (HTTP) processor, a Simple Mail Transfer Protocol (SMTP) processor, or a telephone attendant processor. The user 130 can send in a request through HTTP protocol as http://MAPatTEL.com/123-456-7890. User 130 can also send in the request as an email addressed to the map server 120 as to 123-456-7890@MAPatTEL.com or include the destination phone number in an agreed upon location, e.g., the subject field in the body of the email. User 130 can also make a request through Internet capable phone by calling the phone number of the map server first and then being greeted by an automatic telephone voice attendant system. The telephone attendant processor is to receive and process an incoming telephone call containing messages for requesting a map associated with a destination telephone number, e.g., (123)-456-7890. After receiving the incoming map request, a telephone number normalized process is carried out by a telephone number normalization processor 110. The incoming map request may contain a telephone number as 1-123-456-7890, 123-4567890, 1234567890, or other kinds of variations. The normalization processor 110 normalizes the telephone number to a standard format suitable for a database search. The normalized telephone number is then transferred to the database manager for conducting a two-step search. A first search carried out in the first database search 115-1 is applied to determine an address or location information from the telephone number, and a second step search carried out in a second database 115-2 is to retrieve a map or a link or URL that enables the requester 130 to get the desired map from the address found from the search conducted in first database 115-1. The map or link retrieved from the second database 115-2 is then transmitted to the map requester 130 via the Internet or Internet phone network 100. The first and second databases can be located in a same server or in different servers depending on the hardware and software configurations. The two-step search is included for illustration purpose to implement this preferred embodiment. Other database arrangement is possible. One of the implementation could combine 115-1 and 115-2 into one database and perform a one step search. Another implementation could include an on line open registration process to let the user to populate the database 115-1 and 115-2. The user will register and provide telephone number, associated address and associated map or link to the map to the map server.

In a preferred embodiment, the request handler 105 and the database manager for conducting a database searches in the first and second databases 115-1 and 115-2 are implemented to receive and process partial telephone numbers. The map requests may be received by the request handler 105 as partial number related to the area code or a particular region associated with a prefix number within a bigger area designated with an area code. The map can be retrieved and transferred back to the map requester 130 best fitting the partial telephone number without requiring a complete telephone number to be entered. A map requester is allowed greater degree of flexibility to receive a map associated with an area code, a prefix as a sub-region covered by an area code or a specific location listed for a particular phone number. This feature has a further benefit that many telephone numbers are unlisted with no address provided to the telephone directory. A map requester can still obtain a map related to the bigger area for the purpose of direction guidance without requiring the knowledge of the exact address. In the event that the requester 130's current location can be derived from the map request then a driving direction can be sent back too.

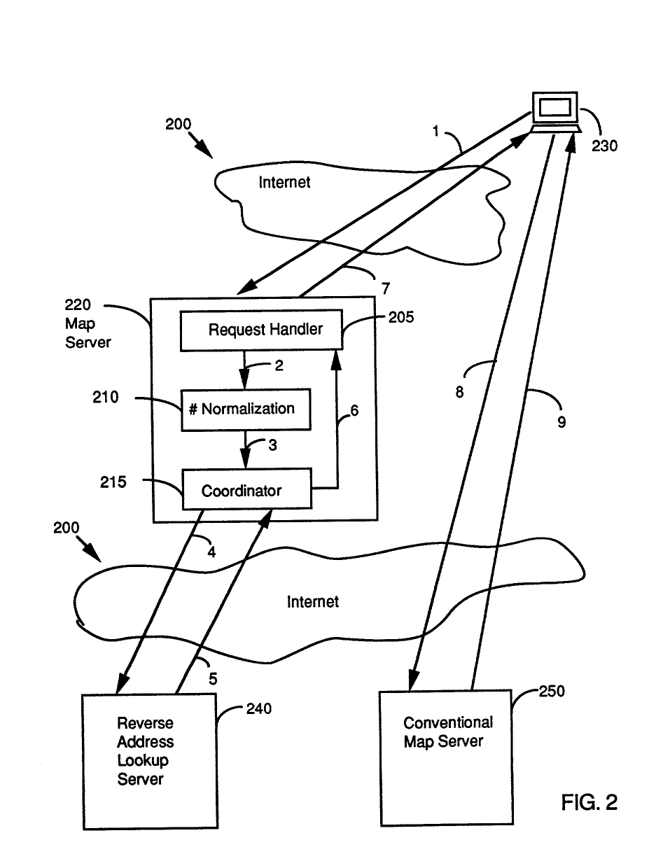

FIG. 2 is a functional block diagram of an alternate embodiment of this invention where an user 230 is sending a map request containing only a telephone number, e.g., www.MAPatTEL.com/123-456-7890 or a partial telephone number, e.g. www.MAPatTEL.com/123-456 through an Internet system 200 to a map server 220. Similar to the map server 120 shown in FIG. 1, the map server 220 also includes a request handler 205 to process the incoming map request and a telephone number normalization processor 210 to normalize the entry of telephone number received as part of the incoming map request. The telephone-number normalization processor 210 then transfers the normalized telephone number to the map-request coordinating processor 215. The map request coordinating processor 215 transmits the normalized telephone number to an reverse address lookup server 240 such as http://www.anywho.com, to retrieve an address or location information for the telephone number entered through the map request. The address or location information generated by the reverse address lookup server 240 is received back by the map request coordinating processor 215 to generate a direct map retrieval request and this map retrieval request is directed to a conventional map server 250 identified by an universal resource location (URL), e.g. http://maps.expedia.com/ default.asp? Street=1+Microsoft+Way&City=Redmond&State=WA&ZIP=98052. The direct map retrieval request directed to the map server is transmitted back to the map requester 230 through the Internet 200. This Internet user 230 receives the direct map retrieval request with an option to either automatically retrieve the map from a conventional map server 250 without intervention from the Internet user 230. Alternately, the Internet user 230 is provided with a button showing a “get map” command for the Internet user to initiate the direct map retrieval request generated by the map server 220 for retrieving the map from the conventional map server 250 such as maps.expedia.com. Again, a partial telephone number is acceptable by the map server 220 for retrieving map associated with an area code or a sub-area associated with a prefix number under an area code.

There are many variations in the implementation of a map server by combining different parts of the processes as described in FIG. 1 and FIG. 2. One example is adding the reverse address lookup server 240 and map request coordinating processor 215 to FIG. 1 to handle the case where a local database search 115-1 does not yield a valid result. Another example is to replace database 115-2 by a map server similar to map server 250. There are many other possibilities to break up and combine the different components to implement a map server.

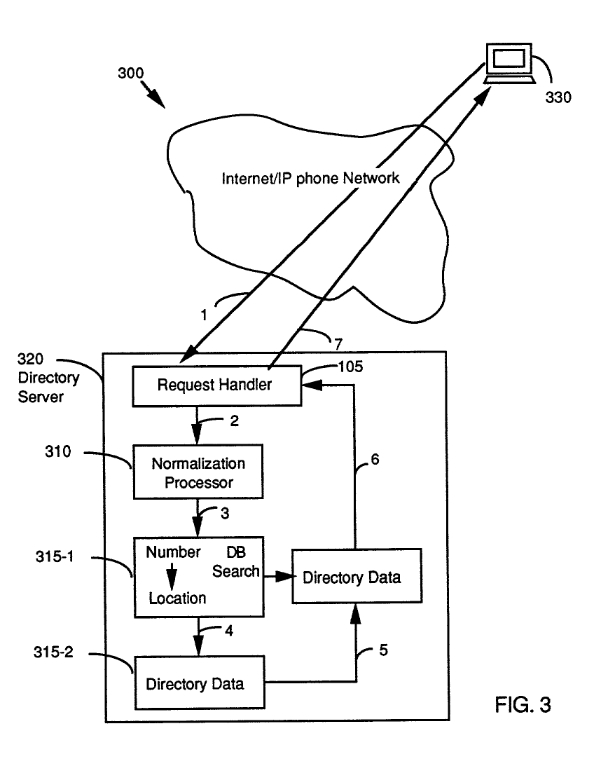

FIG. 3 is a functional block diagram of an alternate embodiment of this invention where an user 330 is sending a directory request for particular geographic location. The directory-request is sent to a directory server 320 and contains only a telephone number or a partial telephone number as part of the URL, e.g., www.YELLOWPAGEatTEL.com/123-456-7890, or, www.YELLOWPAGEatTEL.com/123-456. The directory server 320 receives the directory request through an Internet system 300. Similar to the map server 120 shown in FIG. 1, the directory server 320 also includes a request handler 305 to process the incoming map request. The directory server also includes a telephone number normalization processor 310 to normalize the entry of telephone number or partial telephone number received as part of the incoming directory request. The normalized telephone number is then transferred to the database manager for conducting a two-step search. A first search carried out in the first database search 315-1 is applied to determine a geographic location from the telephone number. And, a second step search carried out in a second database 315-2 is to make available to the user 330 the directory data, e.g., local yellow page data associated with the geographic location found from the search conducted in first database 315-1. Depending on the characteristics of the database 315-2, the result of the first database search 315-1 can be applied as input to the second database search 315-2 to specify the filtering desired. The result of the first database search 315-1 can also be used to do a post filtering 315-3 on search result from 315-2. The result of the first database search can also be used in a combination of pre and post filtering. The directory data for further search in database 315-2 is then made available to the user 330 via the Internet or Internet phone network 300. The result of the first database search 315-1 can also be saved on the requester 330's equipment or on directory server 320 side to be used as filter for future operation. The first and second databases can be located in a same server or in different servers depending on the hardware and software configurations. The two-step search is included for illustration purpose to implement this preferred embodiment. Other database arrangement is possible. One of the implementation could combine 315-1 1 and 315-2 into one database and perform a one step search.

In conducting the first database search to determine a geographic location from database 315-1, the telephone number or partial telephone number is used as a filter to locate the longitude and latitude of the geographic location. One example for such search would be to make available a directory database 315-2 within ten miles of the telephone number for further search by the Internet user. Alternatively, a directory for the entire region assigned with a prefix number, e. g. 494 for a partial telephone number 650-494 entered in the directory request, is made available to the directory requester 330.

According to FIG. 3, this invention discloses a network system. The network system includes a geocentric server 320 for receiving a numeric data input, e.g., a telephone number or a partial telephone number 650-494. The geocentric server 320 further includes a database-search enabling means 305 for enabling a geocentric database search for determining a geographic location, e.g., Palo Alto, Calif., associated with the numeric input. In a preferred embodiment, the geocentric server 320 further includes a geocentric filter means 315-3 for applying the geographic location associated with the numeric input, e.g., the telephone number, to establish a geocentric filter. The geocentric filter 315-3 may be used for filtering a subsequent database search, e.g., a search for bookstores or hotels in that geographic location associated with that telephone number. In a particular embodiment, the geocentric server 320 is provided for receiving a numeric data input that includes at least a first part of a telephone number, e.g., 650-494. And, the geocentric server 320 is provided for enabling a geocentric database search for determining a geographic location, e.g., Palo Alto, Calif., associated with first part of the telephone number, e.g., 650-494. In a particular embodiment, the geocentric server 320 further includes a normalization processor 310 for normalizing the numeric data input, e.g., 1-650-494, into a normalized numeric data input, e.g., 650494, for conducting a geocentric database search.

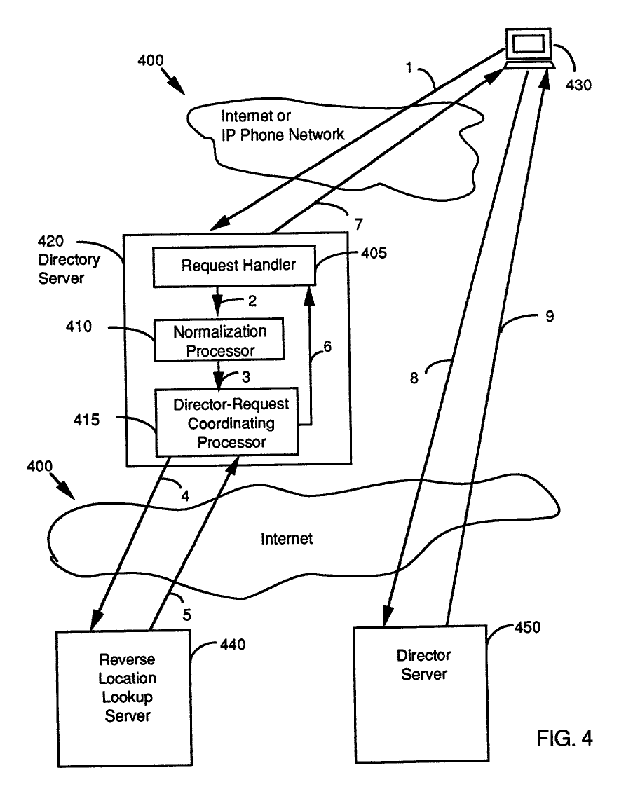

FIG. 4 is a functional block diagram of an alternate embodiment of this invention where an user 430 is sending a directory request for particular geographic location. The directory-request is sent to a directory server 420 and contains only a telephone number or a partial telephone number as part of the URL, e.g., www.YELLOWPAGEatTEL.com/123-456-7890, or, www.YELLOWPAGEatTEL.com/123-456. The directory server 430 receives the directory request through an Internet system 400. Similar to the map server 120 shown in FIG. 1, the directory server 420 also includes a request handler 405 to process the incoming directory request. The directory server also includes a telephone number normalization processor 410 to normalize the entry of telephone number or partial telephone number received as part of the incoming directory request. The normalized telephone number is then transferred to the database manager for conducting a two-step search. The telephone-number normalization processor 410 then transfers the normalized telephone number to the directory-request coordinating processor 415. The directory request coordinating processor 415 transmits the normalized telephone number to a reverse location lookup server 440. An example of such reverse location lookup server is http://www.anywho.com, to retrieve an address or location information for the telephone number entered through the directory request. The address or location information, such as longitude-latitude or zip code data, generated by the address server 440 is received back by the directory request coordinating processor 415. The directory request coordinator 415 then uses the address or location data to generate a direct directory retrieval request. This directory retrieval request is directed to a conventional directory server 450 identified by a universal resource location (URL) e.g.

http://yp.yahoo.com/py/ypBrowse.py?&clr=ypBrowse&ycat=7737166& city=Palo%20Alto&state=CA&slt=37.4172&sln=-122.1309&cs=5&zip=94306. The direct directory retrieval request that is directed to the directory server is transmitted back to the directory requester 430 through the Internet 400. This Internet user 430 receives the direct directory retrieval request with directory data for conducting further searches such as finding out all the Thai restaurant in that area associate with a partial telephone number, e.g., 650-494. There are many ways to implement this on the requester side. For example, the Internet user 430 is provided with a button showing a “get yellow-page” command for the Internet user to initiate the link to the directory database use the URL generated by the directory server 420 for linking to and searching the directory database. Again, a telephone number or partial telephone number is used as filter for the location server 440 to determine a geographic location. With a geographic location specification, the Internet user 430 is linked to an appropriate directory server 450, e.g. yp.yahoo.com to carry out a further search to find out the geographic locations of specific stores or addresses.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

I claim:

1. A method for retrieving a map from an Internet web-site comprising:
a) sending a map request with a telephone number to said Internet web-site; and
b) receiving a map from said Internet web site associated with said telephone number sent with said map request.

2. The method of claim 1 wherein:
said step a) of sending a map request with a telephone number comprising a step of sending said map request to a map server for processing said map request with said telephone number for obtaining an address for said telephone number.

3. The method of claim 2 wherein:
said step b) further comprising a step of retrieving a map of said address.

4. The method of claim 1 wherein:
said step a) of sending a map request with a telephone number comprising a step of sending said map request from a mobile phone to a map server for processing said map request with said telephone number for obtaining an address for said telephone number.

5. The method of claim 4 wherein:
said step a) of sending said map request from a mobile phone to a map server further comprising a step of pushing a map-retrieval key on said mobile phone for logging on to said map server.

6. The method of claim 1 wherein:
said step a) of sending a map request with a telephone number to said Internet web-site further comprising a step of said Internet web site receiving and normalizing said telephone number sent with said map request into a normalized telephone number.

7. The method of claim 6 wherein:
said step a) of sending a map request with a telephone number to said Internet web-site further comprising a step of applying said normalized telephone number for searching an address listed for said normalized telephone number.

8. The method of claim 7 wherein:
said step b) further comprising a step of retrieving a map of said address listed for said normalized telephone number.

9. A method for retrieving a map from network server comprising:
a) sending a map request as a numeric input data to said network server; and
b) receiving a map from said network server associated with said numeric data input sent with said map request.

10. The method of claim 9 wherein:
said step a) of sending a map request as a numeric input data comprising a step of sending said map request to said network server with a partial telephone number.

11. The method of claim 9 wherein:
said step a) of sending a map request as numeric input data comprising a step of sending said map request from a mobile phone to a network server for processing said numeric input data for obtaining a geographic location associated with said numeric input data.

12. An Internet system comprising:
an Internet web site linking to a map server for receiving a map request for a telephone number sent to said Internet web-site; and
said Internet web site comprising a map request processor for enabling a database search for determining a geographic location associated with said telephone number and retrieving a map for said geographic location.

13. The Internet system of claim 12 wherein:
said map request processor further comprising a database for associating said telephone number with a geographic location and associating said geographic location with a map.

14. The Internet system of claim 12 wherein:
said map request processor further comprising a first database for associating said telephone number with a geographic location and a second database for associating said geographic location with a map.

15. The Internet system of claim 12 wherein:
said map request processor further comprising a telephone number normalization processor for normalizing said telephone number sent with said map request into a normalized telephone number for enabling said database search for retrieving a map for said normalized telephone number.

16. The Internet system of claim 12 wherein:
said map request processor further comprising a map request handler for handing said map request submitted in hypertext transfer protocol (HTTP), simple mail transfer protocol (SMTP) and telephonic-tone input as said map request.

17. The Internet system of claim 16 wherein:
said map request handler further comprising a partial telephone number handler for handing said map request submitted with partial telephone number.

18. The Internet system of claim 12 wherein:
said map request processor further comprising an automatic Internet universal resource location (URL) linking processor for linking to several universal resource locations (URLs) for enabling a database search for determining a geographic location associated with said telephone number and for retrieving a map for said geographic location.

19. The Internet system of claim 12 further comprising:
a telephone for sending said map request with a telephone number to said map request processor.

20. The Internet system of claim 19 wherein:
said telephone is a wireless telephone for sending said map request.

21. A network system comprising:
a map server for receiving a numeric data input;
said map server further includes a database-search enabling means for enabling a database search for determining a geographic location associated with said numeric input and a map associated with said geographic location.

22. A network system comprising:
a geocentric server for receiving a numeric data input;
said geocentric server further includes a database-search enabling means for enabling a geocentric database search for determining a geographic location associated with said numeric input.

23. The network system of claim 22 wherein:
said geocentric server further includes a geocentric filter means for applying said geographic location associated with said numeric input to establish a geocentric filter for filtering a subsequent database search.

24. The network system of claim 22 wherein:
said geocentric server is provided for receiving a numeric data input comprising at least a first part of a telephone number; and
said database-search enabling means is provided for enabling a geocentric database search for determining a geographic location associated with said first part of said telephone number.

25. The network system of claim 23 wherein:
said geocentric server further includes a normalization processor for normalizing said numeric data input into a normalized numeric data input.
